(19) United States
(12) Patent Application Publication
(10) Pub. No.: US 2026/0188747 A1
(43) Pub. Date: Jul. 2, 2026

(54) STERILIZABLE LITHIUM ION BATTERIES

(71) Applicants: Wildcat Discovery Technologies, Inc., San Diego, CA (US); Medtronic, Inc., Minneapolis, MN (US)

(72) Inventors: Hui Wang, San Diego, CA (US); Gang Cheng, San Diego, CA (US); Laura Mccalla, Brossard (CA); Prabhakar A. Tamirisa, Brooklyn Park, MN (US); Lu Yu, Shakopee, MN (US); Eric Hanson, Maple Grove, MN (US)

(21) Appl. No.: 19/130,472

(22) PCT Filed: Nov. 14, 2023
(86) PCT No.: PCT/US2023/037248

§ 371 Date: May 15, 2025

Related U.S. Application Data
(60) Provisional application No. 63/427,186, filed on Nov. 22, 2022.

(51) Int. Cl. H01M 10/0569; H01M 4/02; H01M 4/485; H01M 4/58; H01M 10/0525; H01M 10/0568

(52) U.S. Cl. CPC H01M 10/0569; H01M 10/0525; H01M 10/0568; H01M 2004/027; H01M 2004/028; H01M 4/485; H01M 4/5825; H01M 2300/0037

(57) ABSTRACT

A battery that may be exposed to high temperatures such as when steam sterilizing that retains its capacity and power delivery is comprised of a cathode comprised of lithium metal phosphate, an anode comprised of lithium titanate, a separator comprising a material having a melt temperature of at least 150° C. and an electrolyte comprising a low boiling point solvent, a high boiling point solvent and a salt, the salt being comprised of a sulfur containing salt (e.g. lithium bis(trifluoromethanesulfonimide) and a lithium borate salt (e.g., lithium bis(oxalato)borate), by weight, wherein the sulfur containing salt is a majority of the salt present in the electrolyte. Desirably, the low boiling point solvent is comprised of a linear ester and the high boiling point solvent is comprised of a cyclic ester.

### FIELD

The disclosure is directed to lithium ion batteries and in particular to lithium ion batteries that may be subjected to elevated temperatures.

### BACKGROUND

Battery powered medical devices are desirable, but may require sterilization. Lithium ion batteries are highly useful for such devices because of their energy density and ability to deliver sufficient power. However, for these devices to be useful they must be sterilized, which typically requires the use of a steam autoclave (e.g., 134° C. for 18 minutes). Other methods such as the use of hydrogen peroxide vapor are available, but require specialized equipment not commonly available to many hospitals.

Common commercially available lithium ion batteries typically operate in a narrow temperature range (e.g., −20° C. to 60° C.) and use components that evaporate, degrade, or decompose under autoclavable conditions. For example, typical separators comprised of polyethylene deform or melt at the autoclavable temperature. Likewise, common solvents of the liquid electrolytes such as linear carbonates have boiling points less than 140° C. There are some specialty batteries that are designed to operate at extremely high temperatures, including up to 180° C. for deep drilling applications (see, e.g., U.S. Pat. Pub. No. US 2006/0019164 (Bonhommet et al.)). This particular battery exclusively uses high boiling point (bp) solvents (bp greater than ˜140° C.) such as ethylene carbonate (EC) and propylene carbonate (PC). At application temperature, however, these cyclic carbonate solvents have very high viscosities and thus low ionic conductivities, resulting in poor power performance at ambient operating temperatures.

Accordingly, it would be desirable to provide a battery that improves or addresses one or more of the problems of lithium batteries for use in medical applications such as those requiring sterilization by steam autoclaving. In particular, it would be desirable to provide a lithium ion battery that is autoclavable having good capacity retention and power delivery at ambient conditions.

### SUMMARY

Applicant has discovered lithium ion batteries that may be sterilized at high temperatures such as those experienced in steam autoclaves.

In an illustration, a battery comprises a high temperature separator, a cathode comprised of a lithium metal phosphate (e.g., lithium iron phosphate), an anode comprised of a lithium titanate anode, an electrolyte comprised of a salt combination of a lithium salt having a sulfur substituent (e.g., sulfoxide and sulfone) and a lithium borate salt in the absence of a lithium phosphate salt, a low boiling point solvent and a high boiling point solvent.

In another illustration a battery comprises a high temperature separator, a cathode comprised of a lithium metal phosphate (e.g. lithium iron phosphate), an anode comprised of lithium titanate, an electrolyte comprised of a salt and a low boiling point solvent and a high boiling point solvent, wherein the low boiling solvent is comprised of an ester (e.g., such as a lactone desirably having 5 to 6 ring members). Desirably, the low boiling point solvent is comprised of a linear ester (e.g., ethyl butyrate) essentially in the absence of a linear carbonate or any other low boiling solvent (e.g., less than 2%, or 1% by weight).

### DETAILED DESCRIPTION

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

The terms “halo” and “halogen” as used herein refer to an atom selected from fluorine (fluoro, —F), chlorine (chloro, —Cl), bromine (bromo, —Br), and iodine (iodo, —I). The term “aliphatic group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Aliphatic groups may contain atoms, 1-12 carbon atoms, 1-8 carbon atoms, 1-6 carbon atoms, 1-5 carbon atoms, 1-4 carbon atoms, 1-3 carbon atoms, or 1 or 2 carbon atoms. Exemplary aliphatic groups include, but are not limited to, linear or branched, alkyl and alkenyl groups, and hybrids thereof such as (cycloalkyl)alkyl, (cycloalkenyl)alkyl or (cycloalkyl)alkenyl. The aliphatic groups may be unsubstituted or substituted. Substituted means that one or more C or H atoms is replaced with oxygen, boron, sulfur, nitrogen, phosphorus or halogen. Typically, one to six carbon atoms may be independently replaced by the aforementioned and in particular oxygen, sulfur or nitrogen. The aliphatic group may have one or more “halo” and “halogen” atoms selected from fluorine (fluoro, —F), chlorine (chloro, —Cl), bromine (bromo, —Br), and iodine (iodo, —I).

If not otherwise specified any characteristic or property may be determined by standard laboratory practices for determining such properties or characteristics. Illustratively. The melt temperature is the onset melt temperature unless explicitly state otherwise and may be determined as described in ASTM D3418-5. Unless otherwise specified the heating rate of used to determine melt temperature is 20° C./minute by Differential Scanning Calorimetry. The boiling temperature may be determined by ASTM D86 if not generally available in the literature.

The batteries are comprised of a cathode, anode, separator and electrolyte. It is understood that each of these components may be connected or contained with other common components of a battery such as current collectors coated with the anode and cathode and battery containers encompassing the battery components with electrical connection to the battery. For example, the current collector may be any suitable metal (e.g., Al, Alloys of Al and Cu and alloys of Cu) foil, sheet or the like such as a metal foil that may be further coated with an electrically conducting material such as carbon including those described by U.S. Pat. No. 9,172,085, incorporated herein by reference.

The cathode of the battery is comprised of any suitable lithium metal phosphate such as those known in the art. Exemplary lithium metal phosphates include those comprised of one or more of a first row transition metal (e.g., Fe, Co, Mn and Ni). The lithium metal phosphate may be doped with small amounts (5% by weight or less) of other metals. Suitable lithium metal phosphates may include those described by U.S. Pat. Nos. 5,910,382 and 7,029,795, each incorporated herein by reference.

The cathode may further include other cathode components such as binders and electrically conducting additives. The binder may be any suitable such as those known in the art and may include, for example, carboxy methyl cellulose (CMC), styrene-butadiene rubber (SBR), polyvinylidene fluoride (PVDF), poly-tetrafluoroethylene (PTFE), or a mixture of two or more thereof. Desirably, the cathode is comprised of PVDF. The electrically conducting additive may be graphite, carbon black, carbon nanotubes, graphene and carbon fiber.

The amount of other cathode components may be any suitable amount, but generally is at most about 20% or 10% by volume to about 0.1%, 0.5% or 1% by volume of the cathode (i.e., lithium metal phosphate and other cathode components).

The anode is comprised of lithium titanate (oxides of titanium). The lithium titanate may be in any state of lithiation. The lithium titanate may be represented by: Li₄MxTi₅₋ₓO₁₂, wherein M is one or more of Al, Mg, Ni, Co, Fe, Mn, V, Cu, Cr, and Mo and x=0-1); Li₂TiO₃; and LiM′M″XO₄, wherein M′ is one or more of nickel, cobalt, iron, manganese, vanadium, copper, chromium, and molybdenum, niobium; M″ is a three valent non-transition metal (Group 13 metal), and X is zirconium, titanium or combination thereof. Further illustration of lithium titanium oxides having a spinel structure is described in U.S. Pat. No. 7,547,490.

The anode may also be comprised of other additives such as described for the cathode herein. The anode may also be comprised of a small amount of graphitic material capable of intercalating lithium but these are present in an amount of less than 5% or 1% by volume of the cathode. Illustrative graphitic material may be a spherical graphite of an artificial graphite or purified natural graphite. Examples of useful spherical graphites are described in U.S. Pat. Pub. 2016/0141603 and U.S. Pat. No. 9,276,257, each incorporated herein by reference. Examples of suitable commercially available spherical graphites include those available from Syrah Resources, Magnis Resources, Northern Graphite, Focus Graphite and Graphite One.

The separator of the battery may be any that is able to survive steam sterilization conditions and typically has a melt temperature of at least 150° C. The separator may have one or more layers that may be bonded together. Examples of suitable separators includes a poly-imide, polyolefin (such as polypropylene), polyethylene terephthalate, ceramic-coated polyolefin, cellulose, or a mixture of two or more thereof. Such materials may be in the form of microfibers or nanofibers. The separator may include a combination of microfibers and nanofibers. In certain embodiments, the separator includes polyethylene terephthalate microfibers and cellulose nanofibers. Illustrations of separators that may be useful include those described in U.S. Pat. No. 8,936,878, incorporated herein by reference. Further examples of separators include those available from Dreamweaver International (Greer S.C). Typically, the separator is at most 250 micrometers thick to at least about 5 or 10 micrometers thick.

A separator having multiple layers may be used, each of which has a melting point greater than 150° C. However, one of these layers may have a melting point lower than the other layer and may serve the purpose of a shutdown separator. For example, an inner layer of a separator may have a melting point of approximately 130° C. and a layer that may have a melting point of approximately 160° C. In this illustration, the inner layer would melt at a temperature of about 130° C., preventing ion flow in the battery but maintaining separation between the anode and cathode to prevent shorting. In other illustrations, the inner layer of the separator may have a melting point of about 130° C. or slightly above the temperature reached during steam sterilization and the outer layer may have a melting point of >200° C. An example of a useful material having a melting point of approximately 130° C. is high density polyethylene or ultra-high molecular weight polyethylene. Examples of useful materials that have a melting point of >200° C. include polyimide, polyethylene terephthalate, cellulose, aramid fibers, ceramics, and combinations thereof. In certain embodiments, the multiple separator layers with different melting points may be laminated together to form a single multi-layer composite separator. In certain embodiments, a layer of positive temperature coefficient material may be used.

In an illustration of the battery, the electrolyte comprises a low boiling point solvent and a high boiling point solvent and a salt. The high boiling point solvent is a solvent that has a boiling point of at least 140° C., but desirably is at least 160° C., 180° C. or 200° C. to any practical temperature, but typically at most about 350° C. or 300° C. The low boiling point solvent is a solvent that has a boiling point that is less than 140° C., but typically is at most 130° C., 120° C. or even 110° C. to any practical temperature such as at least 70° C., 90° C. or 100° C. Solvent herein is any low molecular weight (typically at most 300 gram/moles, 250 gram/moles or 200 gram/moles) solvent such as a polar aprotic solvent that is useful in dissolving the salt. Generally, the aprotic polar solvents have essentially no water (e.g., less than 100 ppm, 50 ppm or 20 ppm of water by weight).

Generally, the high boiling point solvent is an aprotic polar solvent having a high dielectric constant (e.g., dielectric constants greater than 20, 40, 60 or 80). Examples of such solvents include cyclic aprotic polar solvents having one or more substituted atoms such as O, N, S, and halogen (e.g., F). The dielectric constant may be calculated from the dipoles present in the solvent molecule or determined experimentally such as described in J. Phys. Chem. C 2017, 121, 2, 1025-1031.

Generally, the low boiling point solvents are aprotic polar solvents having a low dielectric constant (e.g., at most about 20, 15 or 10). Examples of such solvents include linear or branched aprotic polar solvents having one or more substituted atoms of O, N, S, and halogen (e.g., F). Examples of such solvents include linear carbonates (e.g., ethylmethyl carbonate (EMC), dimethyl carbonate (DMC), diethyl carbonate (DEC)), as well as certain ethers (such as 1,2-diethoxyethane (DME)), linear esters (e.g., methyl formate, methyl acetate, ethyl acetate, methyl propionate, ethyl butyrate), and nitriles (e.g., acetonitrile). Desirably, the low boiling point solvents are comprised of a linear ester, with or without another low boiling point solvent such as those described above and, in particular, ethyl butyrate. The linear ester is desirably, the majority of the low boiling solvent by weight and may be at least 60%, 70%, 80%, 90% to essentially all of the low boiling point solvent.

The amount of high boiling point solvent and low boiling point solvent present in the electrolyte may be any useful amount that is useful to realize the battery capacity retention desired when exposed to high temperatures. Illustratively, the amount of low boiling solvent/high boiling solvent ratio by weight (solvent ratio) may be 0.1, 0.2, 0.5, 1, 1.2, or 1.5 to 20, 15, 10, 5 or 2.

It has been found that substantial capacity retention and power delivery may be maintained after high temperature exposure (130° C. to 150° C.) when using two or more high boiling point solvents in the electrolyte even when the salt composition is the same or essentially the same as well as the other battery components. Illustratively, the use of two high boiling point solvents with boiling points that are at least 10° C., 20° C. or 30° C. different, and it may be desirable for one of the high boiling point solvents to have a boiling point of 230° C. to 260° C. (e.g., ethylene carbonate (EC), propylene carbonate, (PC), and butylene carbonate (BC)), to realize desirable capacity and power retention after exposure to high temperatures such as experienced in steam sterilization as described in U.S. Pat. No. 11,005,128, from col. 4, line 60 to col. 5, line 47, incorporated herein by reference. Examples of combinations of such high boiling point solvents include one or more of ethylene carbonate (EC), propylene carbonate, (PC), and butylene carbonate (BC) in combination with a sulfolane (e.g., tetramethlyene sulfone (TMS). The sulfolane may be further substituted with a halo group, alkyl and substituted alkyl.

The two or more high boiling point solvents may be present in any useful amount. Generally, each high boiling solvent is present in an amount of at least about 10% to 90% by mole of the high boiling point solvents present in the electrolyte. As an illustration, when two high boiling point solvents are present, one such solvent is present from 10%, 20%, 30%, 40% or 50% by mole with the balance being the other high boiling solvent. Desirably, the higher boiling point solvent is from 30% or 50% to 70% by mole when two high boiling point solvents are present. When three high boiling solvents are present, it is desirable that the solvent with boiling point between the other two is at least about 33%, 40% or 50% by mole of the high boiling solvents present in the electrolyte.

The electrolyte is comprised of a lithium salt comprised of a lithium salt having a sulfur substituent (e.g., sulfoxide and sulfone) and a lithium borate salt and may be in the absence of a lithium phosphate salt depending on the use of a linear ester low boiling point solvent. Illustratively, the sulfur containing lithium salt may be lithium bis (trifluoromethanesulfonimide) and the borate salt may be lithium bis(oxalato)borate (LiBOB). The sulfur containing lithium salt, by weight, is desirably a majority of the salt present in the electrolyte. Desirably, the sulfur containing lithium salt (e.g., lithium bis (trifluoromethanesulfonimide) (LiTFSI)) is present in an amount of at least 50%, 60% or 70% to 90% or 95% of the salt present in the electrolyte, with the balance being the lithium borate salt (e.g., lithium bis(oxalato)borate (LiBOB)), which may include an other salt as further described herein. Illustratively, the sulfur containing salt (e.g., lithium salt having a sulfonyl group)/lithium borate salt molar ratio is at least 1, 1.5, or 2 to 10, 5, with it being desirable for the lithium borate salt to present in a concentration of at least about 0.15 M, 0.2 M to 0.5 M of the electrolyte.

Exemplary other salts include lithium difluoro(oxalate)borate (LiDBOB), lithium bis(pentafluoroethylsulfonyl)imide (Li-BETI), lithium bis(fluorosulfonyl)imide (LiFSI), lithium tetrafluoroborate (LiBF₄), lithium trifluoromethanesulfonate (LiTriflate), lithium hexafluoroarsenate (LiAsF₆), lithium bis(trifluoromethanesulfonimide) (LiTFSI), and lithium hexafluoro-phosphate (LiPF₆). Desirably, the salt may be comprised of LiTFSI, LiBOB and at least one other salt such as an other lithium borate salt (e.g., LiDBOB) and/or lithium phosphate salt (e.g., LiPF₆). The total amount of the salt may be any useful amount of salt and generally may be from 0.5 M, 1 M, 1.1 M, 1.2 M, 1.3 M to 5 M or 2 M.

It has been discovered the batteries of this invention comprised of electrolytes comprised of LiTFSI and LiBOB in the absence of a lithium phosphate salt retain high capacity and power delivery after high temperature exposures better than when a phosphate salt is present. In a particular illustration, the salt is comprised of LiBOB and LiTFSI without a lithium phosphate salt such as LiPF₆. Further salts may be comprised of one or more of a different lithium borate salt (e.g., LiDBOB and LiBF₄) and a lithium sulfur containing salt. When the lithium borate salt and lithium phosphate salt are present, they may be present in any useful molar ratio, but generally, it is desirable that all of the lithium borate salt/lithium phosphate salt molar ratio is at least 1 to 5, 4, 3, 2 or 1.5.

It also has been discovered that the battery may have improved capacity and power retention after heat exposure when the battery is anode capacity limited. That is the areal capacity of the anode is less than the areal capacity of the cathode as expressed by their ratio (N/P).

### Examples

### Cell Preparation and Testing Protocol

Preparation of the LFP cathode was done by mixing carbon coated LFP active material (Johnson Matthey/P2S C—LiFePO₄)) with polyvinylidene difluoride (PVDF, Solvay 5140) and carbon (Li435, Denka) in NMP and coating on an aluminum current collector. The resulting dried electrode is 92 weight % active material, 4 weight % binder, and 4 weight % carbon. Electrode loadings were varied to achieve varying N/P ratios with the LTO (lithium titanium oxide) anode. For N/P of 0.75, the loadings are in the range of 17.5 mg/cm² (˜2.48 mAh/cm²). For N/P of 0.65, the loadings are in the range of 20.4 mg/cm² (˜2.89 mAh/cm²). For N/P of 1.1, the loadings are in the range of 12.0 mg/cm² (˜1.71 mAh/cm²). All electrodes were calendared with a calendared density of 2.3 g/cm³.

The LTO anode material was coated on an aluminum current collector from a slurry containing the active LTO anode material, binder (PVDF, Kureha) and carbon (KS4 and SuperP, Imerys) in NMP (N-Methyl-2-pyrrolidone). The resulting dried electrode is 88.12% active material, 7.36% binder, and 7.36% carbon, with a total mass loading of 12.92 mg/cm². After calendaring, the anode electrode density is 2.1 g/cm³.

Cells were assembled within an argon filled glove box using a Dreamweaver Titanium 18 separator in an environment with less than 0.1 ppm water. Cells were electrochemically tested with accompanying heat cycles, as shown below. Voltage limits were of 0.90 to 2.10 V for all cells. Two sets of batteries having different anode areal capacity/cathode areal capacity were tested (0.75, where the cell capacity is limited by the anode, and 1.1, where the cell capacity is limited by the cathode). If the areal capacity is not explicitly reported it is 0.75. Formation:

Cycle 1 is a C/20 constant current charge to 2.1 V with a subsequent constant voltage hold to C/50, followed by a 20 minute hold at OCV (open circuit voltage). The cell is then discharged at C/20 to 0.9, followed by a 20 minute hold at OCV. Cycle 2 is a C/10 charge to 2.1 V with a constant voltage hold to C/20 and then a 20 minute hold at OCV, followed by discharge at C/10 to 0.9 V and another 20 minute OCV hold. Cycles 3 and 4 are charged to 2.1 V at C/3 with a constant voltage hold to C/20 and a 20 minute OCV hold. Discharge is done at C/3 to 0.9 and another 20 minute OCV hold.

### Cycle Test:

The cycle test is then done at C/2 charge to 2.1 with a CV hold to about C/24 and discharge at C/2 to 0.9 for about 10 cycles. The CV (constant voltage) time is no greater than 3 h.

### Pulse Power Test:

A series of pulse power tests are performed at 95% SOC (state of charge)→80% SOC→60% SOC→40% SOC→20% SOC in a sequence by varying discharge currents (1 C→2C→4 C) for 5 seconds, respectively. Each C-rate pulse will repeat for 10 times and C-rate pulse tests are continuous. After C-rate pulses tests are completed at higher SOC, the cell is then discharged to 0.9 V at C/2 and then a low-rate cycle test is performed at C/10 from 2.1 V to 0.9 V. Afterwards, the cell is recharged to 2.1 V for next series of C-rate pulse tests at lower SOC.

### High Temperature Exposure:

The high temperature exposure test is then performed on the cell while held at 100% SOC. Over 1 to 2 hours, the cell is heated from 25° C. to 135° C. The temperature is then held at 135° C. for 2 hours. The cell is then cooled back to 25° C. over a one-hour time period, after which it is held at OCV for 4 hours at 25° C.

### Post Exposure Tests:

After the high temperature exposure cycle, the cell is discharged to 0.9 V to obtain the remaining capacity. The pulse power test and cycling test are repeated.

Subsequent high temperature exposure, low-rate cycling, and pulse power tests are repeated multiple times and the results after 4 heat exposure cycles is reported compared to the same cells without high temperature exposure unless expressed otherwise.

The Examples and Comparative Examples of Table 1 utilize 30% ethylene carbonate (high boiling point solvent) and 70% by weight ethyl methyl carbonate (low boiling point solvent) and the salt compositions shown in Table 1. From the results, cells having an electrolyte with LiTFSI and LiDBOB without LiPF₆ display improved capacity retention and particularly improved average pulse voltage (higher pulse voltage indicates less loss due to increased resistance in the cell) compared to the Comparative Examples which contain LiPF₆.

The Comparative Examples and Examples cells of Table 2 all use the following salt composition: 0.9 M LiTFSI and 0.2 M LiBOB and the solvents shown in Table 2. The retentions reported in the Table are after 16 high temperature exposures. As shown in Table 2, the use of a linear ester (EB) instead of the linear carbonate (EC) low boiling point solvent results in unexpected substantial improvements in capacity and power retention even in the absence of a phosphate salt in the electrolyte. Likewise, the use of a cyclic ether (GBL) in place of the cyclic carbonate (EC) improves the heat exposure performance.

The battery may have any useful N/P ratio. Desirably the N/P ratio is from 0.5 to 1. The battery capacity and power retention may be further increased by having a battery with a N/P ratio of less than 1 as shown in Table 3, in which a battery that is areal capacity anode limited shows increased capacity and power retention using a linear ester low boiling point solvent. The cells of Table 3 used an electrolyte having 0.9 M LiTFSI and 0.2 M LiBOB. Improved performance after 16 heat exposures has also been seen for electrolytes only having LiTFSI and LiBOB salts, with improvements arising when the LiBOB concentration is increased from 0.2 M to 0.3 M and the LiTFSI concentration remaining the same ˜0.9M.

TABLE 1

| | | | | Remaining Capacity | Discharge Capacity | Avg. Pulse |
|---|---|---|---|---|---|---|
| | LiTFSI | LiBOB | LiPF6 | Retention | Retention | Voltage @ |
| Ex. | (M) | (M) | (M) | (%) | (%) | 1 C 20% SOC |
| 1 | 0.9 | 0.2 | 0 | 93.5 ± 0.6 | 98.6 ± 0.6 | 1.05 |
| C.1 | 0.9 | 0.15 | 0.1 | 83.9 ± 10.6 | 94.2 ± 0.4 | 0.4 |
| C.2 | 0.9 | 0.15 | 0.05 | 93 ± 2.5 | 87.9 ± 22 | 0.1 |

TABLE 2

| | | | | | Remaining Capacity | Discharge Capacity | Average Pulse |
|---|---|---|---|---|---|---|---|
| | EC | EMC | EB | GBL | Retention | Retention | Voltage @ |
| Ex | Parts by weight of solvent | | | | (%) | (%) | 1 C 20% SOC |
| 1 | 3 | 7 | 0 | 0 | 31.1 ± 53.9 | 50.9 ± 37.3 | 0.4 |
| 2 | 3 | 0 | 7 | 0 | 88.3 ± 5.1 | 91.7 ± 4.4 | 0.9 |
| 3 | 0 | 0 | 7 | 3 | 95.9 ± 4.4 | 88.7 ± 4.4 | 1 |

Note:
Example 1 is the same in each Table, but the data reported in Tables 2 and 3 are after 16 high T exposures.

TABLE 3

| | | | | | | Remaining Capacity | Discharge Capacity | Average Pulse |
|---|---|---|---|---|---|---|---|---|
| | | EC | EMC | EB | GBL | Retention | Retention | Voltage @ |
| Ex | N/P | Parts by weight of solvent | | | | (%) | (%) | 1 C 20% SOC |
| 1 | 0.75 | 3 | 7 | 0 | 0 | 31.1 ± 53.9 | 50.9 ± 37.3 | 0.4 |
| 4 | 0.75 | 3 | 0 | 7 | 0 | 88.3 ± 5.1 | 91.7 ± 4.4 | 0.9 |
| 5 | 0.75 | 0 | 0 | 7 | 3 | 95.9 ± 1.9 | 88.7 ± 4.4 | 1 |
| C.4 | 1.1 | 3 | 7 | 0 | 0 | 30.4 ± 47.2 | 47.2 ± 14.8 | 0.33 |
| 6 | 1.1 | 3 | | 7 | 0 | 85.9 ± 3.5 | 61.0 ± 1.0 | 0.47 |
| 7 | 1.1 | 0 | | 7 | 3 | 74.1 ± 38.2 | 51.0 ± 12.5 | 20.62 |

1. A battery comprising a high temperature separator, a cathode comprised of a lithium metal phosphate, an anode comprised of a lithium titanate anode, an electrolyte comprised of a salt that has a sulfur containing lithium salt and a lithium borate salt in the absence of a lithium phosphate salt, a low boiling point solvent and a high boiling point solvent, the low boiling point solvent being comprised of a linear ester.

2. The battery of claim 1, wherein the sulfur containing lithium salt/lithium borate salt ratio is at least 1 to 10.

3. (canceled)

4. The battery of claim 1, wherein the sulfur containing lithium salt is a lithium salt having a sulfonyl group.

5. The battery of claim 4, wherein the lithium salt having the sulfonyl group is comprised of lithium bis(trifluoromethanesulfonimide).

6. The battery of claim 5, wherein the lithium borate salt comprises lithium bis(oxalate)borate.

7. (canceled)

8. (canceled)

9. The battery of claim 1, wherein the salt is comprised of one or more of lithium difluoro(oxalate)borate (LiDBOB), lithium bis(pentafluoroethylsulfonyl)imide (Li-BETI), lithium bis(fluorosulfonyl)imide (LiFSI), lithium tetrafluoroborate (LiBF₄), lithium trifluoromethanesulfonate (LiTriflate), and lithium hexafluoroarsenate (LiAsF₆).

10. The battery of claim 1, wherein the low boiling point solvent is comprised of one or more of a linear carbonate, linear ether, and linear nitrile.

11. (canceled)

12. The battery of claim 1, wherein the linear ester is comprised of ethyl butyrate.

13. The battery of claim 1, wherein the low boiling point solvent and high boiling point solvent are present in a solvent ratio of low boiling solvent/high boiling solvent of greater than 1 to 20 by weight.

14. The battery of claim 13, wherein the solvent ratio is 1.5 to 5.

15. The battery of claim 1 wherein the high boiling point solvent is comprised of a cyclic ester having a 5 or 6 ring member lactone.

16. (canceled)

17. The battery of claim 15, wherein the cyclic ester is comprised of gamma butyrolactone.

18. The battery of claim 1, wherein each high boiling point solvent has a boiling point of 200° C. to 300° C. and is cyclic and the low boiling point solvent has a boiling point of at most 120° C.

19. The battery of claim 18, wherein the high boiling point solvent is comprised of two or more high boiling point solvents having boiling points that are at least 20° C. different.

20. (canceled)

21. A battery comprises a high temperature separator, a cathode comprised of a lithium metal phosphate, an anode comprised of lithium titanate, an electrolyte comprised of a salt and a low boiling point solvent and a high boiling point solvent, wherein the low boiling point solvent is comprised of a linear ester ester.

22. The battery of claim 21, wherein the ester is the sole low boiling point solvent.

23. (canceled)

24. (canceled)

25. The battery of claim 21, wherein the electrolyte is comprised of a sulfur containing lithium salt and a lithium borate salt.

26. (canceled)

27. The battery of claim 25, wherein the salt is comprised of a sulfur containing salt and lithium borate salt, the sulfur containing salt/lithium borate salt being at a ratio of 1 to 10.

28. (canceled)

29. The battery of claim 25, wherein the sulfur containing salt is a lithium salt having a sulfonyl group.

30. (canceled)

31. (canceled)

32. The battery of claim 21, wherein the high boiling point solvent is comprised of a cyclic ester and the cyclic ester is comprised of has a 5 or 6 ring member lactone.

33. (canceled)

34. (canceled)

35. (canceled)

36. The battery of claim 32, wherein the high boiling point solvent is comprised of two or more high boiling point solvents having boiling points that are at least 20° C. different.

37. (canceled)
